(19) United States
(12) Patent Application Publication
(10) Pub. No.: US 2015/0114020 A1
(43) Pub. Date: Apr. 30, 2015

(54) Agricultural Tractor with Air Conditioning Compressor Drive

(71) Applicant: MacDon Industries Ltd., Winnipeg, CA (US)

(72) Inventor: Leonard Bergman, Winnipeg (CA)

(21) Appl. No.: 14/448,657

(22) Filed: Jul. 31, 2014

Related U.S. Application Data
(60) Provisional application No. 61/895,758, filed on Oct. 25, 2013.

(51) Int. Cl. B60H 1/32; B62D 49/00

(52) U.S. Cl. CPC B60H 1/3222; B60H 1/3204; B62D 49/00
USPC 62/244

(57) ABSTRACT

An agricultural tractor includes a frame, ground wheels including drive wheels, an operator cab carried on the frame, an engine mounted in an engine compartment on the frame at a position longitudinally spaced from the cab, a cooling assembly within the engine compartment for cooling the engine with the fan on the cooling assembly being driven by a hydraulic motor. An air conditioning system for cooling the cab includes a compressor in the engine compartment driven directly or indirectly by the same hydraulic motor so that it is driven at the rate of the fan rather than the rate of the engine. The engine control system controls both the cooling fan and the compressor using a clutch to disconnect the compressor when not required or when the fan is driven in reverse direction.

This application claims the benefit under 35 USC 119 (e) of Provisional Application 61/895758 filed Oct. 25 2013.

This invention relates an agricultural tractor such as a tractor, swather tractor or combine harvester and particularly to an improved arrangement for driving the air conditioning compressor for the air conditioning system in the cab. In particular the invention relates to an improved air conditioning system in which the compressor of the air conditioning system is powered by the engine cooling fan.

### BACKGROUND OF THE INVENTION

Conventionally the air conditioning compressor of an agricultural tractor is driven by a belt from the accessory drive pulley of the engine

### SUMMARY OF THE INVENTION

According to the invention therefore there is provided an agricultural tractor comprising:
a frame extending in a longitudinal direction the tractor;
a plurality of rotatable ground wheels connected to the frame to convey the frame over the ground, including drive wheels operable to drive the tractor in a forward working direction along the longitudinal direction of the tractor;
an operator cab carried on the frame;
an engine mounted in an engine compartment on the frame at a position longitudinally spaced from the cab;
a cooling assembly at the engine compartment for cooling the engine;
a hydraulic motor driving a fan on the cooling assembly;
an air conditioning system arranged for cooling the cab of the tractor including an air conditioning compressor;
wherein the air conditioning compressor is driven from the hydraulic motor.

In one arrangement, dependent on the geometry of the system, the air conditioning compressor can be driven through a pulley arrangement driven by the shaft of the hydraulic motor.

In another arrangement, the air conditioning compressor can be mounted on a shaft of the hydraulic motor and is driven directly thereby.

In accordance with an important aspect of the invention there is provided a clutch for disconnecting drive from the hydraulic motor to the air conditioning compressor, the clutch being controlled by a control system of the tractor. This allows the drive to the air conditioning compressor to be halted when required.

Preferably the control system is arranged to operate the clutch in response to a signal from the control system activating a reverse drive cycle of the cooling fan to prevent reverse rotation of the air conditioning compressor when the fan on the cooling system is reversed for cleaning the cooling system

Preferably the fan on the cooling system is closer to an evaporator coil of the air conditioning system than is an accessory drive pulley of the engine.

Preferably the air conditioning compressor is driven by the hydraulic motor at a rate which is dependent on engine cooling requirements so that the drive to the air conditioning compressor is independent of engine speed.

Thus the air conditioning compressor can be driven at a reduced rate during periods of low heat loads so that a thermostat can provide reasonable compressor cycle times and prevent rapid on and off cycling of the compressor.

Thus the air conditioning compressor can be driven at an increased rate during periods of high heat loads due to the higher speed of the cooling fan.

The advantage to powering and mounting the compressor of the air conditioning system within the housing of the radiator and driven directly, or indirectly of the shaft of the fan is that the lines of the air conditioner can be shorter from evaporator to compressor and compressor to condenser resulting in less refrigerant loss over time and reduced cost. Also allows the compressor to be independent of the engine, thereby using common parts, being the same drive system and hoses for all engines. As well as higher heat loads caused by high ambient heat will cause the compressor to turn faster when engaged. Also the compressor RPMs will be reduced during periods of low heat loads caused by low ambient heat reducing the need for an electronic thermostat to prevent the compressor from switching on and off rapidly.

### BRIEF DESCRIPTION OF THE DRAWINGS

One embodiment of the invention will now be described in conjunction with the accompanying drawings in which:

FIG. 1 is a schematic plan view of one type of agricultural equipment, this example being a swather.

FIG. 2 is a cross sectional view of the cooling system of one embodiment of the present invention.

FIG. 3 is a cross sectional view of another embodiment of the present invention.

FIG. 4 is a cross sectional view of a third embodiment of the present invention.

In the drawings like characters of reference indicate corresponding parts in the different figures.

### DETAILED DESCRIPTION

The present invention can be utilized in any commonly known agricultural machine such as a combine harvester, tractor or swather. In this embodiment the present invention is shown within a swather but can vary widely in accordance with requirements, as is well know to a person skilled in this art.

A swather 1 includes an engine 3 carried on a frame 5, adjacent a first end 7. The frame is carried on a first pair of driven ground wheels 9 and a second pair of non-driven castor wheels 11. The driven wheels are mounted on suitable supports 13 which support the ground wheels from the frame. The driven ground wheels are driven by a hydraulic motor carried on the support which receives hydraulic fluid under pressure from a supply line that drives the ground wheel at a rate of rotation dependant upon the rate of flow of the hydraulic fluid.

The castor wheels are mounted on conventional castors 15 which swivel about a castor pin 17. The ground wheels are non driven and are simply mounted in a supporting bracket 20 which can pivot around the castor pin so that the castor wheels follow the movement of the vehicle as controlled by the driven wheels. Thus the speed of the vehicle over the ground is controlled by the rate of rotation of the wheels and steering is controlled by a differential in speed between the wheels.

The frame is shown only schematically since this can vary widely in accordance with requirements, as is well known to a person skilled in this art. At the driven end 11A of the frame is mounted suitable supports 21 and 22 for carrying a header 23A. Again these elements are well known to persons skilled in this art and various different designs can be used. Thus the support elements 21, 22 on the header carried thereby are shown only schematically. Various different types of headers can be used including disc type cutters or sickle knife cutters. The width of the header can vary considerably depending upon the type of crop and the cutting system employed. The header is preferably carried on the tractor rather than on separate supports and the tractor includes a lifting mechanism schematically indicated at 23 operable to raise and lower the header on the tractor between different working positions, and between working positions and a raised position cleared from the ground for moving the header over the ground when not in working position.

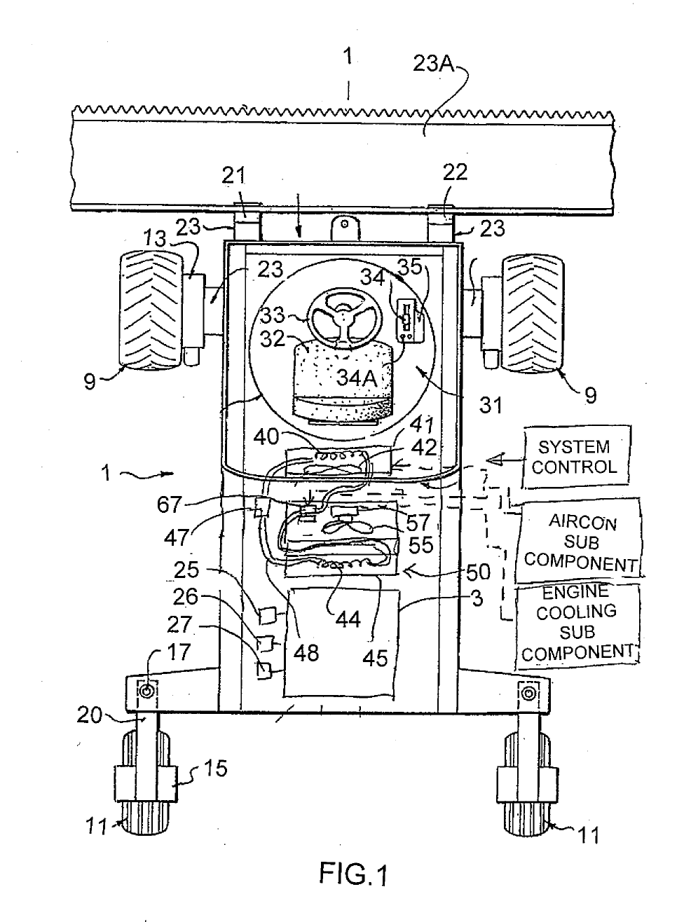

The tractor includes the engine 3 carried on the frame 11 adjacent a second end 11B of the frame. The engine is arranged to drive a series of pumps 25, 26 and 27 for generating pressurized hydraulic fluid for driving the various components of the tractor. Separate pumps can be used as shown or single pump can be used with the hydraulic fluid under pressure generated thereby being separated into separate controlled fluid paths for operating the various components, or in a parallel arrangement such as on the M-series windrowers manufactured by the present assignee. The operator console 31 may be of the type described in U.S. Pat. No. 7,159,687 of the present assignee, where the console is arranged to be rotatable about an upright axis between a first position (illustrated in FIG. 1) where the seat faces the driven end 11A of the machine and a second position (not shown) in which the seat faces the engine end 116 of the machine. The first of these positions is known herein as a “field” or “cab forward” mode where the operator console faces the header 23A for use of the same in the field with the machine driven in the illustrated working direction F. The other position may be known as a “transport” or “engine forward” mode, where the operator console faces the engine end 11B of the machine for road transport of the machine by driving of same in an opposite direction in which engine leads the cab.

A radiator assembly 50 mounted within the engine compartment is arranged to cool the engine by way of a coolant flowing through a cooling circuit. The radiator assembly has a housing or shroud 52 which is arranged to house the components of the radiator assembly. As commonly known to one skilled in the art, the radiator provides cooling to the engine by driving a fan 55. In this example, the fan is driven by a hydraulic motor 57 mounted on a rotatable shaft 59. The fan is mounted on the shaft so as to be driven directly by the motor. As an alternative it could also be indirectly driven (e.g. by belt) from the motor.

An air conditioning system for the cab includes an evaporator coif 40 within a housing 41 in the cab with a fan 42 arranged to drive air over the coil 40 into the cab for cooling the operator. A condenser coil 44 is located at a location 45 on the exterior of the tractor and cooled by the fan 55 using outside air. A compressor 67 is provided with a valve 47 in a circuit to complete the conventional air conditioning system. The present invention relates to an improved arrangement for driving the compressor 67 of the air conditioning circuit 48.

The condenser coil 44 is provided as part of the engine cooling system so that it is cooled by the same fan 55 as the engine cooling system 50. As shown these components are mounted directly behind the cab in front of the engine. Thus the condenser coil 44 is located closely adjacent the evaporator coil 40 and the circuit 48 has very short leads since the compressor 67 is located between the coils.

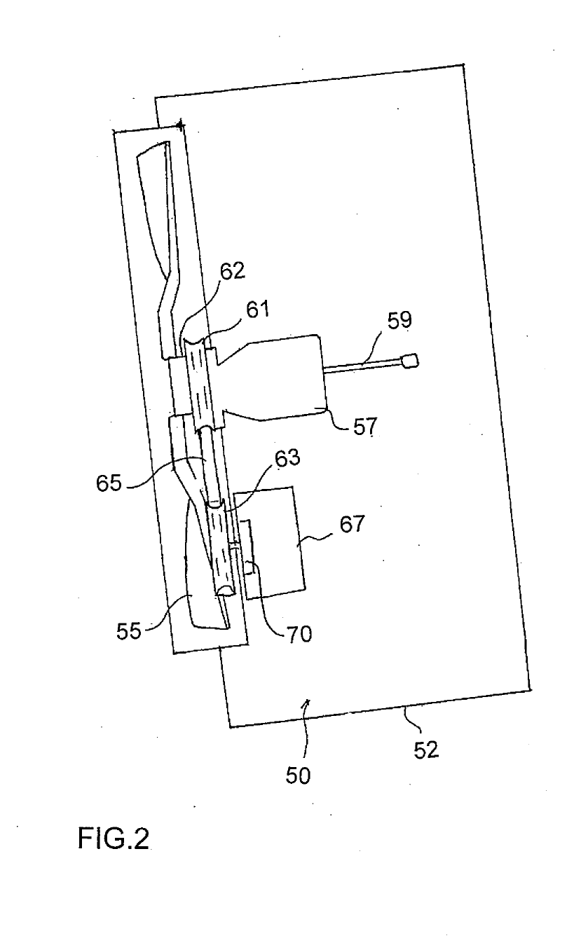

In a first embodiment of the present invention, as illustrated in FIG. 2, a pulley 61 is mounted on the shaft 59, between the motor and the fan at a hub 62 of the fan 55. The pulley 61 is arranged to be driven by the motor using hydraulic power taken from the engine which drives one of the pumps 25, 26, 27 which provides oil to the motor at the same RPM as the fan 55. A second pulley 63 is mounted within the housing 52 adjacent the first pulley 61 and the pulleys are connected to each other by a belt 65. A compressor 67 of an air conditioning system, as commonly known to someone skilled in this art, is mounted to the second pulley within the radiator housing. The compressor 67 therefore is arranged to be powered by the fan motor 57.

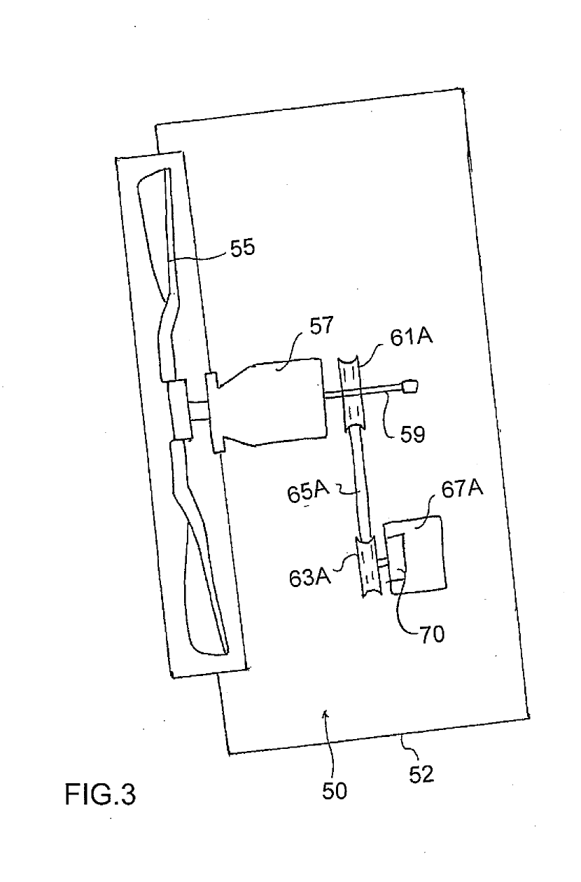

In a second embodiment of the present invention, as illustrated in FIG. 3, the first pulley 61A is mounted on the shaft 59 but behind the hydraulic motor 57 in relation to the fan 55. The second embodiment is similar is design to the first embodiment in that the first pulley is connected to a second pulley 63A through a belt 65A. The second pulley is arranged to provide power to the compressor 67A of the vehicle's air conditioning system.

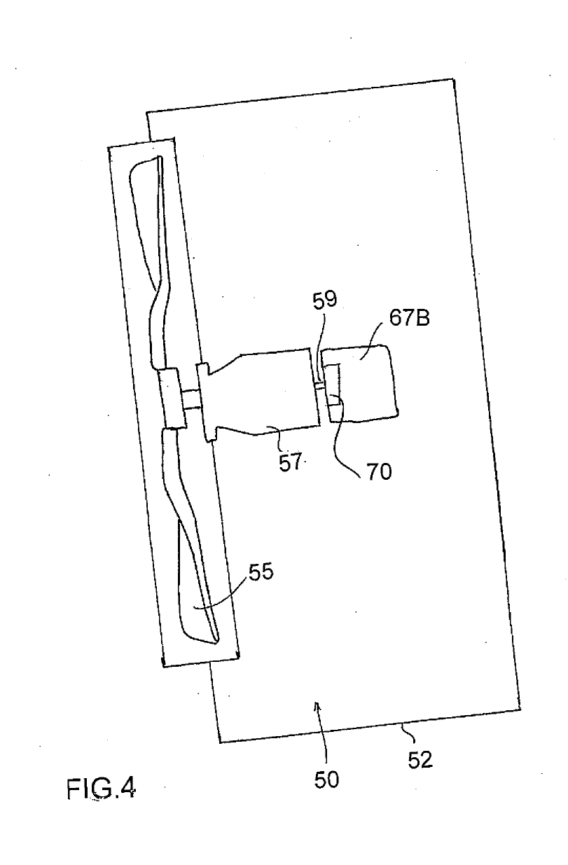

In a third embodiment of the present invention, as illustrated in FIG. 4, the compressor 67B is mounted directly on the shaft 59 of the motor 57 such that the compressor is driven by the shaft 59, without the use of pulleys.

The tractor includes an electronic control system 100 which operates all control aspects of the tractor including various operator inputs and sensor inputs well known to a person skilled in this art. This system includes an air conditioning control sub-component 101 which controls the air conditioning system in response to operator input within the cab and temperature sensors within the cab. The system 100 also includes an engine cooling subcomponent 102 which controls the speed of the fan 55 dependent on engine cooling requirements and controls a reverse fan cycle for periodic cleaning of the radiator by reverse drive to the fan to blow off contaminants. There is also provided a clutch 70 for disconnecting drive from the hydraulic motor to the air conditioning compressor 67, the clutch being controlled by the control system 100, 101 of the tractor. This allows the drive to the air conditioning compressor to be halted when required by the airconditioning control system.

The control system 101 is arranged also to operate the clutch 70 in response to a signal from the control system 102 activating a reverse drive cycle of the cooling fan to prevent reverse rotation of the air conditioning compressor when the fan on the cooling system is reversed for cleaning the cooling system.

The air conditioning compressor 67 is driven by the hydraulic motor 57 at a rate which is dependent on engine cooling requirements as determined by the control system 102 so that the drive to the air conditioning compressor is independent of engine speed.

Thus the air conditioning compressor 67 is driven at a reduced rate during periods of low heat loads so that there is no need for an electronic thermostat used to prevent rapid on and off cycling of the compressor.

Thus the air conditioning compressor 67 is driven at an increased rate during periods of high heat loads due to the higher speed of the cooling fan.

The fan 57 on the cooling system is closer to the evaporator coil 40 of the air conditioning system than is the accessory drive pulley of the engine so that the lines of the circuit 48 are reduced in length.

1. An agricultural tractor comprising:
a frame extending in a longitudinal direction the tractor;
a plurality of rotatable ground wheels connected to the frame to convey the frame over the ground, including drive wheels operable to drive the tractor in a forward working direction along the longitudinal direction of the tractor;
an operator cab carried on the frame;
an engine mounted in an engine compartment on the frame at a position longitudinally spaced from the cab;
a cooling assembly at the engine compartment for cooling the engine;
a hydraulic motor driving a cooling fan on the cooling assembly;
an air conditioning system arranged for cooling the cab of the tractor including an air conditioning compressor;
wherein the air conditioning compressor is driven from the hydraulic motor at a rate determined by the hydraulic motor.

2. The tractor according to claim 1 wherein the air conditioning compressor is driven through a pulley arrangement driven by the hydraulic motor.

3. The tractor according to claim 1 wherein the air conditioning compressor is mounted on a shaft of the hydraulic motor and is driven directly thereby.

4. The tractor according to claim 1 wherein there is provided a clutch for disconnecting drive from the hydraulic motor to the air conditioning compressor, the clutch being controlled by a control system of the tractor.

5. The tractor according to claim 4 wherein the control system is arranged to operate the clutch to prevent reverse rotation of the air conditioning compressor when the fan on the cooling system is reversed for cleaning the cooling system

6. The tractor according to claim 1 wherein the fan on the cooling system is closer to an evaporator coil of the air conditioning system than is an accessory drive pulley of the engine.

7. The tractor according to claim 1 wherein the air conditioning compressor is driven by the hydraulic motor at a rate which is dependent on engine cooling requirements.

8. The tractor according to claim 7 wherein the air conditioning compressor is driven at a reduced rate during periods of low heat loads so that an electronic thermostat can provide reasonable compressor cycle times and prevent rapid on and off cycling of the compressor.

9. The tractor according to claim 7 wherein the air conditioning compressor is driven at an increased rate during periods of high heat loads due to the higher speed of the cooling fan.

10. The tractor according to claim 1 wherein the drive to the air conditioning compressor is independent of engine speed.
